(19) United States
(12) Patent Application Publication
(10) Pub. No.: US 2026/0106723 A1
(43) Pub. Date: Apr. 16, 2026

(54) Managing Uplink Transmission Chain Switching Period Location

(71) Applicant: GOOGLE LLC, Mountain View, CA (US)

(72) Inventors: Kao-Peng Chou, Taoyuan City (TW); Chih-Hsiang Wu, Taoyuan City (TW)

(21) Appl. No.: 19/116,974

(22) PCT Filed: Sep. 29, 2023
(86) PCT No.: PCT/US23/75645

§ 371 Date: Mar. 28, 2025

Related U.S. Application Data
(60) Provisional application No. 63/377,705, filed on Sep. 29, 2022.

(51) Int. Cl. H04L 5/00; H04W 72/20

(52) U.S. Cl. CPC H04L 5/0098; H04L 5/0005; H04L 5/0044; H04W 72/20

(57) ABSTRACT

A method in a user equipment (UE) equipped with a plurality of transmitters includes receiving (314), from a radio access network (RAN), an uplink switching configuration that indicates, for a plurality of frequency bands including a first frequency band and a second frequency band, respective priorities. The method also includes determining (334), for an uplink transmission to the RAN and based on the respective priorities, whether to allocate a time resource in a first slot associated with the first frequency band or a second slot associated with the second frequency band, the time resource being for the UE to switch at least one of the plurality of transmitters from the first frequency band to the second frequency band.

### CROSS-REFERENCE TO RELATED APPLICATIONS

This application claims priority to and the benefit of the filing date of provisional U.S. Patent Application No. 63/377,705 entitled “MANAGING UPLINK TRANSMISSION CHAIN SWITCHING PERIOD LOCATION,” filed on Sep. 29, 2022. The entire contents of the provisional application are hereby expressly incorporated herein by reference.

### FIELD OF THE DISCLOSURE

This disclosure relates to wireless communications and, more particularly, to supporting uplink (UL) transmitter switching between multiple carrier frequencies or frequency bands.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

For some user equipment (UE), if a UE has two transmitters and is configured with physical uplink (UL) shared channel (PUSCH) configurations on component carriers on two bands, the UE configures one transmitter (also referred to as a “Tx” or an antenna) for component carrier(s) on one band and configures another transmitter for component carrier(s) on another band. In some such cases, the UE is scheduled to transmit 1-port transmission on component carrier(s) on one band and two concurrent 1-port transmissions on component carriers on two bands. However, for a case where the base station only schedules 1-port transmission on one band, only one transmitter is used, leaving the other transmitter idle. To better utilize the idle transmitter, UL switching technology supports scenarios such as inter-band evolved universal terrestrial radio access network (E-UTRAN) new radio (NR) dual connectivity (DC) (EN-DC) without supplementary uplink (SUL), inter-band UL carrier aggregation (CA), and standalone SUL. With UL switching, a UE is able to configure both transmitters for the same band. As such, in some such scenarios, the UE is additionally scheduled with 2-port transmission (UL-MIMO) on a carrier on one band.

When a UE switches antenna configuration to a carrier on one band from another carrier on another band, the UE determines the starting location (e.g., in one of the carriers) of the switching period based on an RRC parameter (e.g., uplinkTxSwitchingPeriodLocation) in the serving cell configuration. If the value of the RRC parameter (e.g., uplinkTxSwitchingPeriodLocation) is set to TRUE in the serving cell configuration of carrier 1, the switching period occurs in slot of the carrier 1, regardless of whether the antenna switches to or from the carrier 1. Likewise, if the value of the RRC parameter (e.g., uplinkTxSwitchingPeriodLocation) is set to FALSE in the serving cell configuration of carrier 1, the switching period occurs in slot of the carrier 2, regardless of whether the antenna switches to or from the carrier 2. If the base station configures the value of the RRC parameter (e.g., uplinkTxSwitchingPeriodLocation) as TRUE to carrier(s) on one band, the base station configures the value of the RRC parameter (e.g., uplinkTxSwitchingPeriodLocation) as FALSE to carrier(s) on another band.

### SUMMARY

An example embodiment of the techniques of this disclosure is a method in a UE equipped with a plurality of transmitters. The method includes receiving, from a RAN, an uplink switching configuration that indicates, for a plurality of frequency bands including a first frequency band and a second frequency band, respective priorities; and determining, for an uplink transmission to the RAN and based on the respective priorities, whether to allocate a time resource in a first slot associated with the first frequency band or a second slot associated with the second frequency band, the time resource being for the UE to switch at least one of the plurality of transmitters from the first frequency band to the second frequency band.

Another example embodiment of these techniques is a UE comprising one or more processors and configured to perform the method above.

Another example embodiment of these techniques is a method in a RAN node, the method comprising transmitting, to a UE equipped with a plurality of transmitters, an uplink switching configuration that indicates, for a plurality of frequency bands including a first frequency band and a second frequency band, respective priorities, the respective priorities being for use by the UE to determine, for an uplink transmission to the RAN, whether to allocate a time resource in a first slot associated with the first frequency band or a second slot associated with the second frequency band, and the time resource being for the UE to switch at least one of the plurality of transmitters from the first frequency band to the second frequency band.

Yet another example embodiment of these techniques is a RAN node comprising one or more processors and configured to perform the method above.

### BRIEF DESCRIPTION OF THE DRAWINGS

FIG. 1A is a block diagram of an example wireless communication system in which a RAN and/or a UE implement the techniques of this disclosure for managing Tx state for UL switching;

FIG. 1B is a block diagram of an example base station including a central unit (CU) and a distributed unit (DU) that can operate in the system of FIG. 1A;

FIG. 2 is a block diagram of an example protocol stack according to which the UE of FIG. 1A communicates with base stations;

FIG. 3 is a messaging diagram of an example of UL switching;

FIG. 4A is a messaging diagram for delivering a UL switching configuration under DC with a particular cell group configuration path;

FIG. 4B is a messaging diagram similar to that of FIG. 4A, in which the scenario is performed using a different cell group configuration path;

FIG. 5 is a flow diagram of an example method 500 describes a general UE procedure in determining UL Tx switching period location;

FIG. 6 is a flow diagram of an example method 600, where a UE determines the UL Tx switching period location according to a cell index configured by the base station;

FIG. 7A is a flow diagram of an example method 700, where a UE determines the UL Tx switching period location in accordance with the cell/band priority configured by the base station;

FIG. 7B is a flow diagram of an example method 700, where a UE determines the UL Tx switching period location according to serving cell indexes configured by the base station;

FIG. 8 is a flow diagram of an example method 800, where a UE determines the UL Tx switching period location according to the UL Tx switching period location indication of each UL switching cases (e.g., band pairs) configured by the base station;

FIGS. 9A and 9A is a flow diagram of an example method 900, where a UE determines the UL Tx switching period location according to the UL Tx switching period location indicator carried by a scheduling DCI format.

FIGS. 10A and 10B are a flow diagrams of an example method 1000A and 1000B, where a UE determines the UL Tx switching period location in accordance with single or multiple UL Tx switching period location configurations.

FIGS. 11A, 11B, 11C, 11D, 11E, 11F, and 11G are flow diagrams of example method 1100A, 1100B, 1100C, 1100D, 1100E, 1100F, and 1100G illustrating the base station procedures generally corresponding to the UE methods 600, 700A, 700B, 800, 900A, 900B, 1000A, 1000B.

### DETAILED DESCRIPTION OF THE DRAWINGS

Generally speaking, the techniques of the disclosure introduce a UL switching configuration with Tx selection indication for UE to configure Tx states across cells in at least 3 frequency bands. UE triggers UL switching based on base station scheduled (by DCI or RRC) UL transmissions. In some scenarios, a scheduled UL transmission may associate with multiple Tx states, which introduces ambiguity between base station and UE. With the antenna selection indication in the UL switching configuration, UE follows the UL switching rules to update the Tx state, thereby resolves the non-unique Tx state issue.

As such, the instant techniques increase the number of supported bands to 3 and 4. For example, a base station configures UL carriers on bands A, B, and C to a UE, and the UE supports antenna switching in band pairs A-B, A-C, and B-C. In current techniques, if the base station configures the switching period location in band A, the UE does not know where the switching period should be allocated when switching from carrier(s) on band B to carrier(s) on band C. In another example, if the base station configures the switching period location in band A and band B, the UE may not know where the switching should be allocated when switching between carrier(s) on band A and band B. As such, the instant techniques illustrate how to indicate the switching period location to the UE.

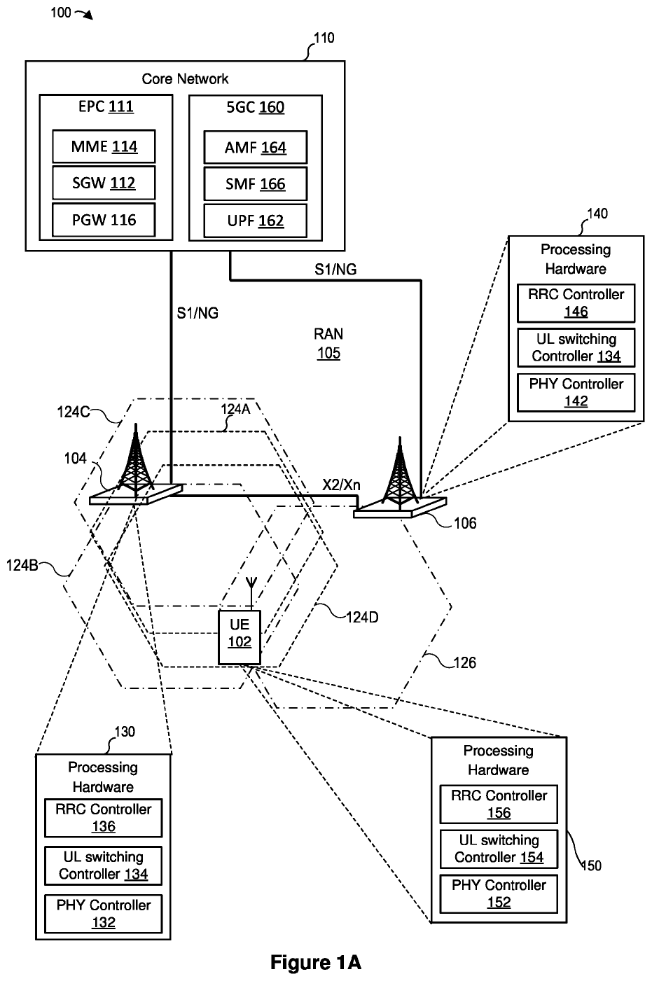

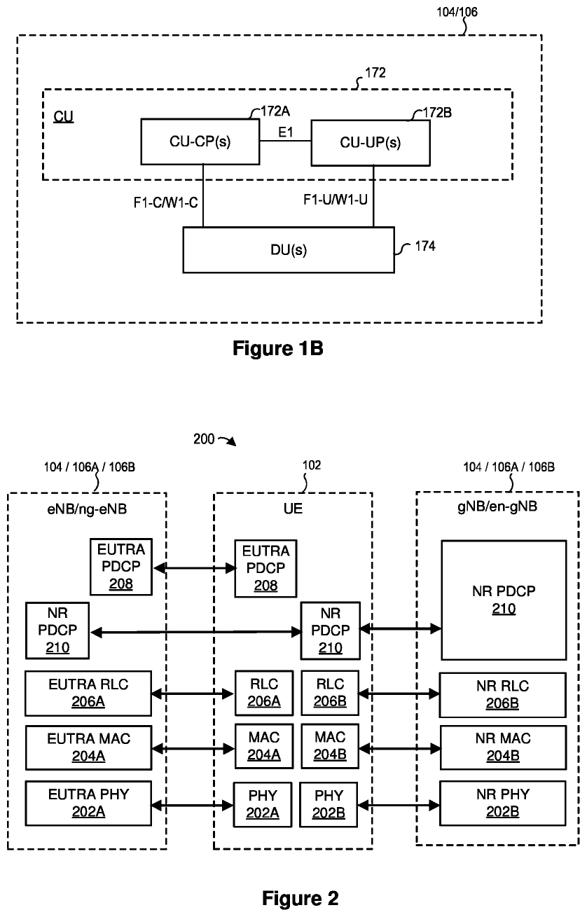

FIG. 1A depicts an example wireless communication system 100 that can implement UL switching techniques of this disclosure. The wireless communication system 100 includes UE 102A and UE 102B, as well as base stations 104, 106A, 106B of a radio access network (RAN) (e.g., RAN 105) that are connected to a core network (CN) 110. To ease readability, UE 102 is used herein to represent the UE 102A, the UE 102B, or both the UE 102A and UE 102B, unless otherwise specified. The base stations 104, 106A, 106B can be any suitable type, or types, of base stations, such as an evolved node B (eNB), a next-generation eNB (ng-eNB), or a 5G Node B (gNB), for example. As a more specific example, the base station 104 can be an eNB or a gNB, and the base stations 106A and 106B can be gNBs.

The base station 104 supports a cell 124, the base station 106A supports a cell 126A, and the base station 106B supports a cell 126B. The cell 124 partially overlaps with both of cells 126A and 126B, such that the UE 102 can be in range to communicate with base station 104 while simultaneously being in range to communicate with base station 106A or 106B (or in range to detect or measure the signal from both base stations 106A and 106B). The overlap can make it possible for the UE 102 to hand over between cells (e.g., from cell 124 to cell 126A or 126B) or base stations (e.g., from base station 104 to base station 106A or base station 106B) before the UE 102 experiences radio link failure, for example. Moreover, the overlap allows the UE 102 to operate in dual connectivity (DC) with the RAN 105. For example, the UE 102 can communicate in DC with the base station 104 (operating as a master node (MN)) and the base station 106A (operating as a secondary node (SN)) and, upon completing a handover to base station 106B, can communicate with the base station 106B (operating as an MN). As another example, the UE 102 can communicate in DC with the base station 104 (operating as an MN) and the base station 106A (operating as an SN) and, upon completing an SN change, can communicate with the base station 104 (operating as an MN) and the base station 106B (operating as an SN).

More particularly, when the UE 102 is in DC with the base station 104 and the base station 106A, the base station 104 operates as a master eNB (MeNB), a master ng-eNB (Mng-eNB), or a master gNB (MgNB), and the base station 106A operates as a secondary gNB (SgNB) or a secondary ng-eNB (Sng-eNB).

The UE 102 includes processing hardware 150, which can include one or more general-purpose processors (e.g., CPUs) and a computer-readable memory storing machine-readable instructions executable on the general-purpose processor(s), and/or special-purpose processing units. The processing hardware 150 in the example implementation of FIG. 1A includes a UE UL switching controller 152 that is configured to manage UE Tx state for UL transmission. For example, the UE UL switching controller 152 can be configured to support RRC configurations, procedures and messaging associated with UL switching procedures, and/or to support the necessary operations, as discussed below.

The CN 110 can be an evolved packet core (EPC) 111 or a fifth-generation core (5GC) 160, both of which are depicted in FIG. 1A. The base station 104 can be an eNB supporting an S1 interface for communicating with the EPC 111, an ng-eNB supporting an NG interface for communicating with the 5GC 160, or a gNB that supports an NR radio interface as well as an NG interface for communicating with the 5GC 160. The base station 106A can be an EUTRA-NR DC (EN-DC) gNB (en-gNB) with an S1 interface to the EPC 111, an en-gNB that does not connect to the EPC 111, a gNB that supports the NR radio interface and an NG interface to the 5GC 160, or a ng-eNB that supports an EUTRA radio interface and an NG interface to the 5GC 160. To directly exchange messages with each other during the scenarios discussed below, the base stations 104, 106A, and 106B can support an X2 or Xn interface.

Among other components, the EPC 111 can include a Serving Gateway (SGW) 112, a Mobility Management Entity (MME) 114, and a Packet Data Network Gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. The UPF 162 is generally configured to transfer user-plane packets related to audio calls, video calls, Internet traffic, etc., the AMF 164 is configured to manage authentication, registration, paging, and other related functions, and the SMF 166 is configured to manage PDU sessions.

Generally, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure can also apply to other suitable radio access and/or core network technologies such as sixth generation (6G) radio access and/or 6G core network or 5G NR-6G DC, for example.

In different configurations or scenarios of the wireless communication system 100, the base station 104 can operate as an MeNB, an Mng-eNB, or an MgNB, the base station 106B can operate as an MeNB, an Mng-eNB, an MgNB, an SgNB, or an Sng-eNB, and the base station 106A can operate as an SgNB or an Sng-eNB. The UE 102 can communicate with the base station 104 and the base station 106A or 106B via the same radio access technology (RAT), such as EUTRA or NR, or via different RATs.

When the base station 104 is an MeNB and the base station 106A is an SgNB, the UE 102 can be in EN-DC with the MeNB 104 and the SgNB 106A. When the base station 104 is an Mng-eNB and the base station 106A is an SgNB, the UE 102 can be in next generation (NG) EUTRA-NR DC (NGEN-DC) with the Mng-eNB 104 and the SgNB 106A. When the base station 104 is an MgNB and the base station 106A is an SgNB, the UE 102 can be in NR-NR DC (NR-DC) with the MgNB 104 and the SgNB 106A. When the base station 104 is an MgNB and the base station 106A is an Sng-eNB, the UE 102 can be in NR-EUTRA DC (NE-DC) with the MgNB 104 and the Sng-eNB 106A.

FIG. 1B depicts an example, distributed implementation of any one or more of the base stations 104, 106A, 106B. In this implementation, the base station 104, 106A, or 106B includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include the processing hardware 130 or 140 of FIG. 1A.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures when the base station (e.g., base station 106A) operates as an MN or an SN. The processing hardware can also include a physical layer controller configured to manage or control one or more physical layer operations or procedures.

In some implementations, the CU 172 can include a logical node CU-CP 172A that hosts the control plane part of the Packet Data Convergence Protocol (PDCP) protocol of the CU 172 and/or radio resource control (RRC) protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit the UL switching control information.

The CU-CP 172A can be connected to multiple CU-UP 172B through the E1 interface. The CU-CP 172A selects the appropriate CU-UP 172B for the requested services for the UE 102. In some implementations, a single CU-UP 172B can be connected to multiple CU-CP 172A through the E1 interface. The CU-CP 172A can be connected to one or more DU 174s through an F1-C interface. The CU-UP 172B can be connected to one or more DU 174 through the F1-U interface under the control of the same CU-CP 172A. In some implementations, one DU 174 can be connected to multiple CU-UP 172B under the control of the same CU-CP 172A. In such implementations, the connectivity between a CU-UP 172B and a DU 174 is established by the CU-CP 172A using Bearer Context Management functions.

FIG. 2 illustrates, in a simplified manner, an example protocol stack 200 according to which the UE 102 can communicate with an eNB/ng-eNB or a gNB (e.g., one or more of the base stations 104, 106A, 106B).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to the EUTRA PDCP sublayer 208 and, in some cases, to the NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides RLC channels to the NR PDCP sublayer 210. The UE 102, in some implementations, supports both the EUTRA and the NR stack as shown in FIG. 2, to support handover between EUTRA and NR base stations and/or to support DC over EUTRA and NR interfaces. Further, as illustrated in FIG. 2, the UE 102 can support layering of NR PDCP 210 over EUTRA RLC 206A, and an SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets”. The packets can application content for different services, e.g., IPv4/IPv6 multicast delivery, IPTV, software delivery over wireless, group communications, IoT applications, V2X applications, and/or emergency messages related to public safety.

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 can be SDAP PDUs, Internet Protocol (IP) packets or Ethernet packets.

In scenarios where the UE 102 operates in EN-DC with the base station 104 operating as a MeNB and the base station 106A operating as an SgNB, the wireless communication system 100 can provide the UE 102 with an MN-terminated bearer that uses EUTRA PDCP sublayer 208, or an MN-terminated bearer that uses NR PDCP sublayer 210. The wireless communication system 100 in various scenarios can also provide the UE 102 with an SN-terminated bearer, which uses only the NR PDCP sublayer 210. The MN-terminated bearer can be an MCG bearer, a split bearer, or an MN-terminated SCG bearer. The SN-terminated bearer can be an SCG bearer, a split bearer, or an SN-terminated MCG bearer. The MN-terminated bearer can be an SRB (e.g., SRB1 or SRB2) or a DRB. The SN-terminated bearer can be an SRB or a DRB.

To simplify the following description, the UE 102 represents the UE 102A and the UE 102B, unless explicitly described.

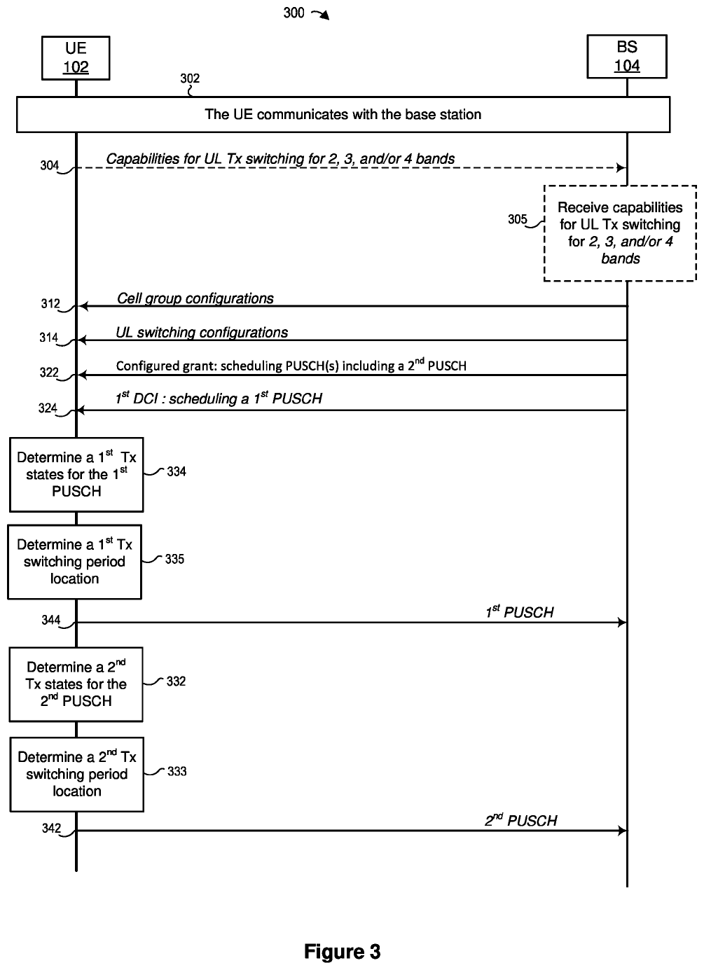

FIG. 3 shows an example scenario 300, which depicts message passing procedures for UL switching, where the UE 102 is equipped with a first and second Tx. The procedures begin with event 302, where the base station 104 communicates with the UE 102 to request UE capabilities regarding UL switching. In response to event 302, the UE 102 transmits 304, to the base station 104, capabilities for UL Tx switching for multiple (e.g., 2, 3, and/or 4) bands, wherein the capabilities for UL Tx switching include UL switching related information such as band combinations, band pair list, MIMO capability per component carrier, supported UL switching options, switching period, etc. At event 305, the base station 104 receives capabilities for UL Tx switching for multiple (e.g., 2, 3, and/or 4) bands. Then the base station 104 transmits 312 a cell group configuration to the UE 102, wherein the cell group configuration includes SpCell configuration (e.g., SpCellConfig), SCell configuration (e.g., SCellConfig), and other parameters for UE 102 to transmit and/or receive signals from multiple cells. The base station 104 transmits 314 a UL switching configuration to the UE 102, including carrier indexes (e.g., uplinkTxSwitchingCarrier) UL switching options, UL Tx switching period location (e.g., uplinkTxSwitchingPeriodLocation), etc.

Then the base station 104 transmits 322 a configured grant to the UE 102, scheduling one or more PUSCH transmissions including scheduling 342 a second PUSCH transmission. The base station 104 transmits 324 a first downlink control information (DCI) to the UE 102, where the first DCI schedules a first PUSCH transmission 344. In response to the first DCI, the UE 102 determines 334 a first Tx state for the first and second Tx. In response to the first Tx state, the UE 102 determines 335 a first Tx switching period location and configure the first and second Tx to the first Tx state by using the first Tx switching period. The UE transmits 344 the first PUSCH to the base station 104 with the first Tx state. Then, according to the configured grant, the UE 102 determines 332 a second Tx state for the first and second Tx. In response to the second Tx state, the UE 102 determines 333 a second Tx switching period location and configures the first and second Tx to the second Tx state by using the second Tx switching period. The UE transmits 342 the second PUSCH to the base station 104 with the second Tx state.

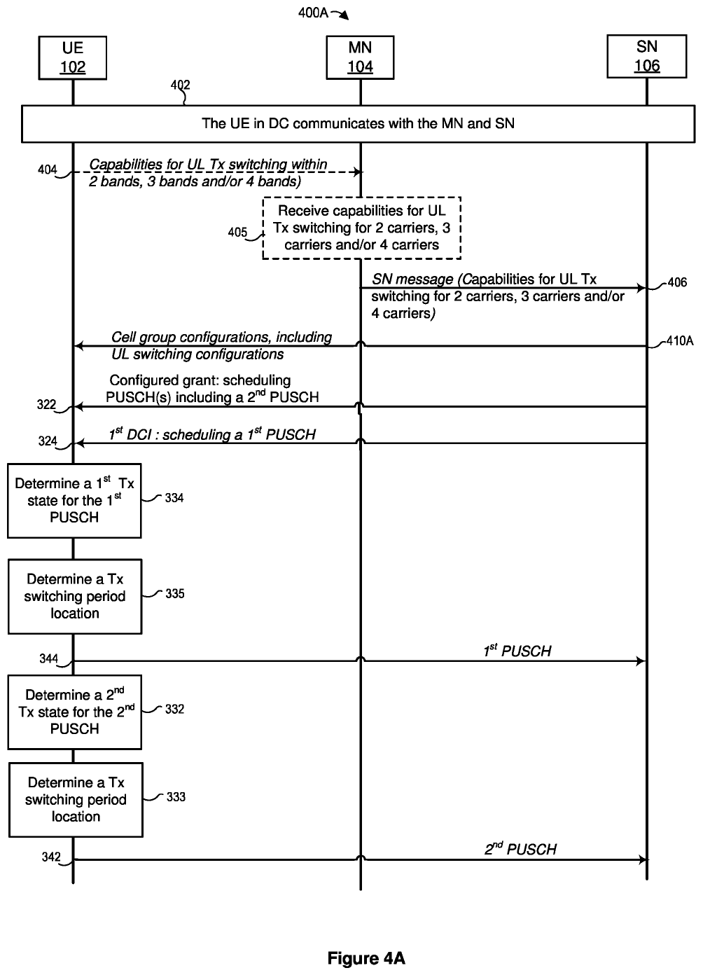

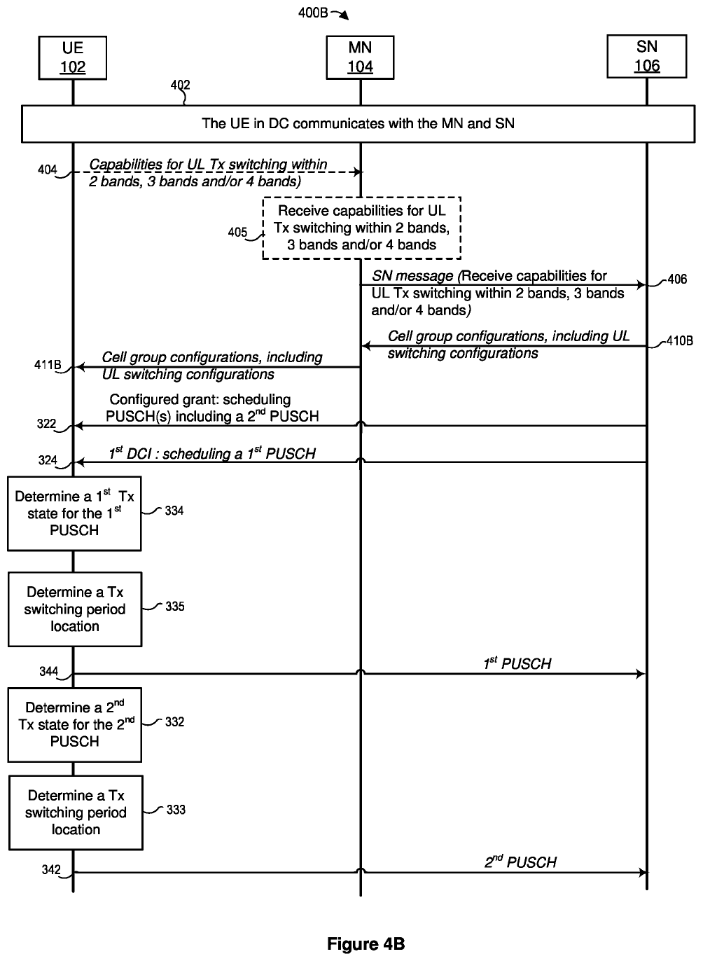

FIG. 4A shows an example scenario 400A, which is similar to the scenario 300, with differences described below. At event 402, the UE 102 communicates with MN 104 and SN 106 to request UE capabilities regarding UL switching. In response to event 402, the UE 102 transmits 404, to the MN 104, capabilities for UL Tx switching for multiple (e.g., 2, 3, and/or 4) bands. At event 405, the MN 104 receives 404 capabilities for UL Tx switching for multiple (e.g., 2, 3, and/or 4) bands. Then the MN 104 sends 406, to the SN 106, a SN message, including capabilities for UL Tx switching for multiple (e.g., 2, 3, and/or 4) bands. In accordance with the SN message 406, the SN 106 transmits 410A, to the UE 102, a cell group configuration including UL switching configurations.

FIG. 4B shows an example scenario 400A, which is similar to the scenario 300 and 400A with differences described below. In accordance with the SN message 406, the SN 106 sends 410B, to the MN 104, a cell group configuration including UL switching configurations. Then the MN 104 transmits 411B, to the UE 102, a cell group configuration including UL switching configurations.

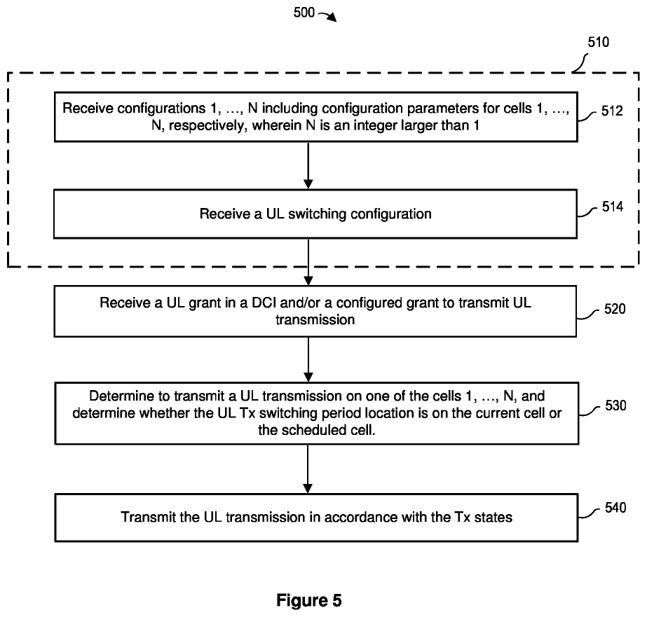

FIG. 5 illustrates a method 500 for UE procedures in UL switching, which can be applied to the scenario 300 in FIG. 3, scenario 400A in FIG. 4A, and/or scenario 400B in FIG. 4B. The flow begins at block 512, where the UE (e.g., UE 102) receives configurations 1, . . . , N including configuration parameters for cells 1, . . . , N, respectively, wherein N is an integer larger than 1 (e.g., cell group configurations, event 312). At block 514, the UE 102 receives (e.g., event 314) a UL switching configuration. At block 520, the UE 102 receives, from the base station 104, a UL grant in a DCI and/or a configured grant (e.g., events 322, 324) to transmit PUSCH(s). At block 530, the UE 102 determines to transmit a UL transmission on one of the cells 1, . . . , N, and determine whether the UL Tx switching period location is on the current cell or the scheduled cell. Finally, at block 540, the UE 102 transmits the UL transmission (e.g., events 342, 344) according to the Tx states.

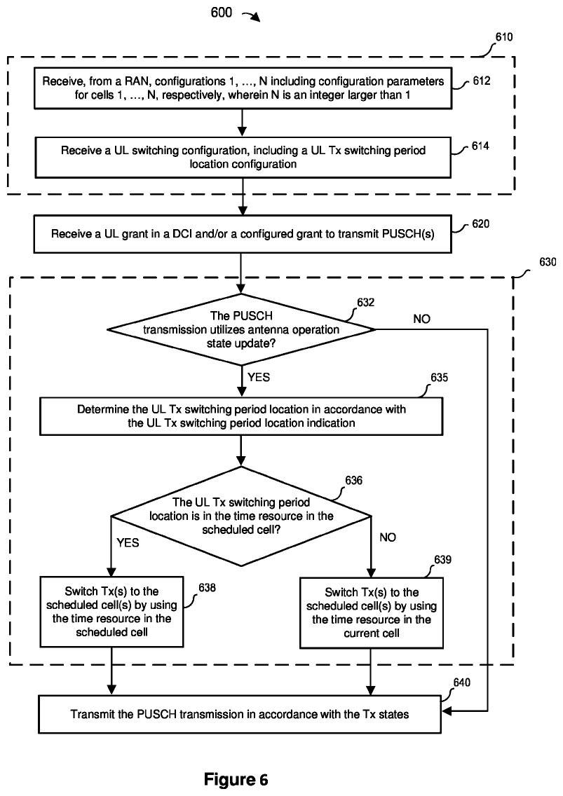

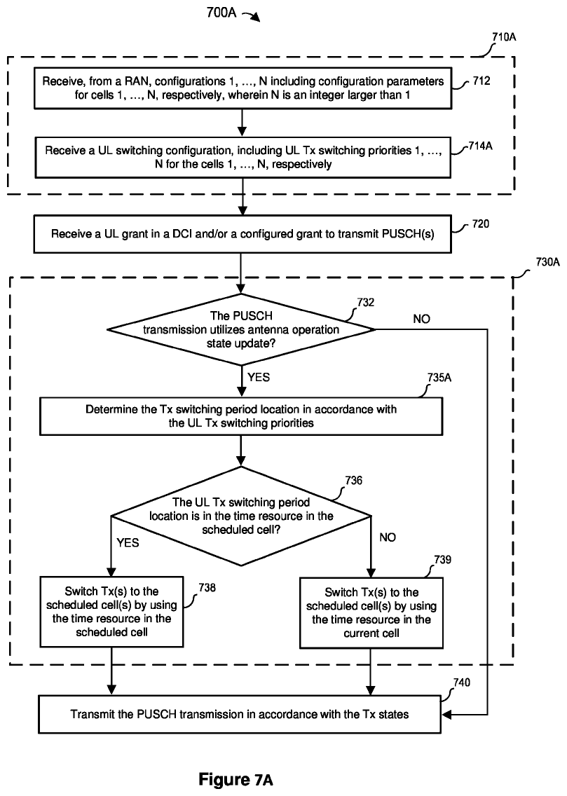

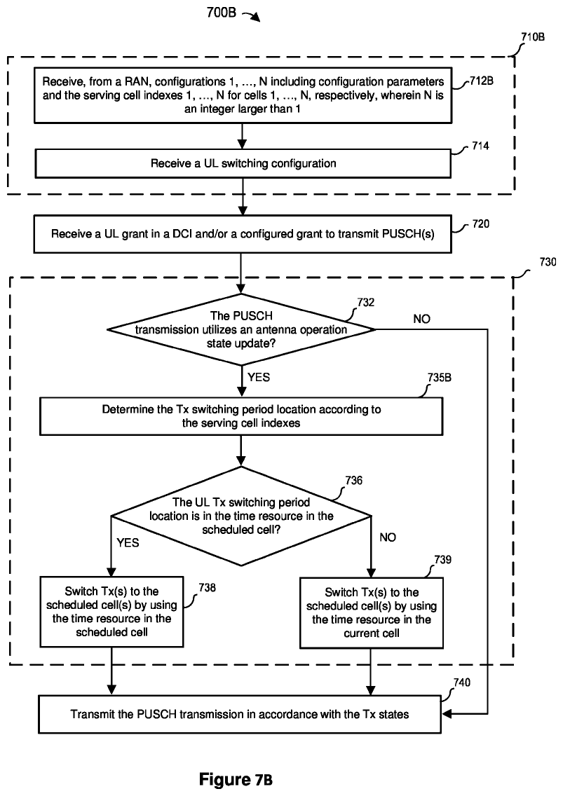

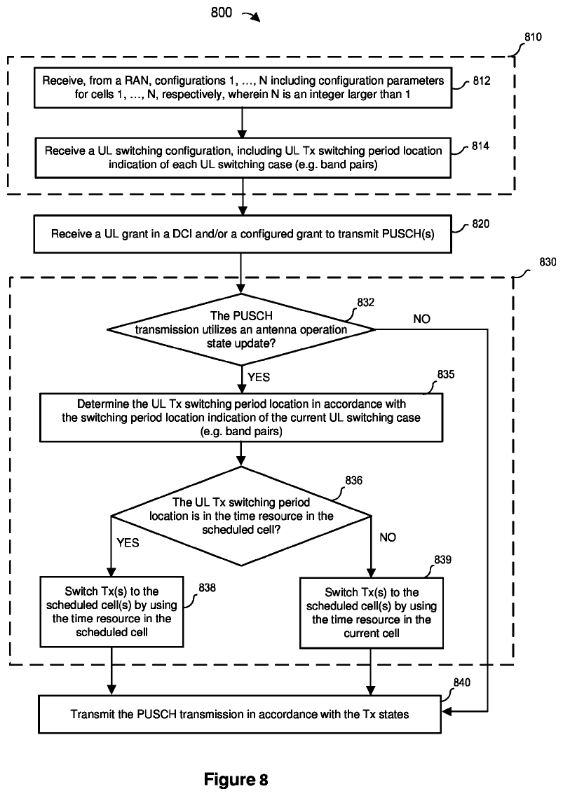

FIGS. 6, 7A, 7B, 8, 9A, and 9B depict detailed procedures and variations of method 500 for a UE to determine UL Tx switching period location. Generally speaking, events in FIGS. 5-9B that are similar are labeled with similar reference numbers (e.g., event 512 is similar to event 612 of FIG. 6, event 712 of FIGS. 7A and 7B, etc.), with differences discussed below where appropriate. With the exception of the differences shown in the figures and discussed below, any of the alternative implementations discussed with respect to a particular event (e.g., for messaging and processing) may apply to events labeled with similar reference numbers in other figures. Further, it will be understood that FIGS. 6-9B can depict expanded views of events in FIG. 5. For example, block 630 of FIG. 6 including blocks 632, 634, 636, and 637 can detail an expanded view of block 530 of FIG. 5, denoted by a dashed line surrounding the component events. As such, it will be understood that implementations with regard to such expanded events can apply to the version in FIG. 5 and vice versa

FIG. 6 illustrates an example method 600 of UE procedures that is similar to the method 500, with differences described below. At block 614, the UE receives a UL switching configuration, including a UL Tx switching period location indication. At block 632, if the PUSCH transmission does not utilize a Tx state update, the flow proceeds to block 640 where the UE transmits the PUSCH according to the Tx state. At block 632, if the PUSCH transmission utilizes a Tx state update, the flow proceeds to block 635. At block 635, the UE determines the UL Tx switching period location in accordance with the UL Tx switching period location configuration. At block 636, if the UL Tx switching period location indicates the scheduled cell, the flow proceeds to the block 638. At block 638, the UE configures Tx(s) to the scheduled cell(s) by using the time resource in the scheduled cell. At block 636, if the UL Tx switching period location does not indicate the scheduled cell, the flow proceeds to block 639. At block 639, the UE configures Tx(s) to the scheduled cell(s) by using the time resource in the current cell. The flow also continues to block 640 from blocks 638 and/or 639.

In one example, the UL Tx switching period location configuration is an RRC parameter uplinkTxSwitchingPeriodLocation-r18 under the cell group configuration (e.g., cellGroupConfig) with a value of BOOLEAN (i.e., TRUE or FALSE). If the value is TRUE, the UL Tx switching period location occurs in the current cell/band, otherwise (FALSE), the UL Tx switching period location occurs in the scheduled cell/band.

As an example of method 600 applicable to scenario 300, the base station 104 transmits 312 a cell group configuration to the UE 102, including first, second, and third serving cell indexes for a first, second, and third cell on the first, second, and third bands, respectively (e.g., event 512). The base station 104 transmits 314 a UL switching configuration to the UE 102 (e.g., event 614), including a UL Tx switching period location configuration indicating to use the current cell. In some implementations, the UE 102 has a first and second Tx to UL transmission, and the current Tx states are the first Tx configured for the first cell and the second Tx configured for the second cell. Then the base station 104 transmits 324 a first DCI scheduling a 2-port transmission (first PUSCH) on the first cell. And the first DCI indicates to use time resource in current cell for Tx switching. In accordance with the UL Tx switching period location configuration at block 614, the UE 102 uses a time resource in the second cell to configure the second Tx for the first cell (e.g., event 335). Then the UE 102 transmits 344 the first PUSCH to the base station 104.

FIG. 7A illustrates an example method 700A of UE procedures that is similar to the method 500 and 600, with differences described below. At block 714A, the UE (e.g., UE 102) receives a UL switching configuration (e.g., events 314, 514), including UL Tx switching priorities 1, . . . , N for the cells 1, . . . , N, respectively (e.g., uplinkSwitchingPrioirty for each serving cell). At block 735A, the UE 102 determines a UL Tx switching period location in accordance with the UL Tx switching priorities of the current cell/band and the scheduled cell/band.

As an example of method 700A applicable to scenario 300, the base station 104 transmits 312 a cell group configuration to the UE 102, including first, second, and third serving cell indexes for a first, second, and third cell on the first, second, and third bands, respectively (e.g., event 512). The base station transmits 314 a UL switching configuration to the UE 102 (e.g., event 614), including UL Tx switching priorities 1, . . . , N for the cells 1, . . . , N, respectively. In some implementations, the UE 102 has a first and second Tx to UL transmission, and the current Tx states are the first Tx configured for the first cell and the second Tx configured for the second cell. Then the base station 104 transmits 324 a first DCI scheduling a 2-port transmission (first PUSCH) on the first cell. At block 335, if the second cell has a higher priority value than the first cell, the UE 102 determines to use the time resource in the second cell for the Tx switching. As such, the UE 102 uses a time resource in the second cell to configure the second Tx for the first cell. Then the UE 102 transmits 344 the first PUSCH to the base station 104.

FIG. 7B illustrates an example method 700B of UE procedures that is similar to the method 500 and 600, with differences described below.

At block 712B, the UE (e.g., UE 102) receives configurations 1, . . . , N including configuration parameters and the serving cell indexes 1, . . . , N for cells 1, . . . , N, respectively, wherein N is an integer larger than 1. At block 735B, the UE 102 determine the UL Tx switching period location based on the serving cell indexes.

The example of method 700B applicable to scenario 300 is similar to the example for method 700A applicable to scenario 300, with differences described below. At block 335, if the second cell has a smaller serving cell index than the first cell, the UE 102 determines to use the time resource in the second cell for the Tx switching. As such, the UE 102 uses a time resource in the second cell to configure the second Tx for the first cell.

FIG. 8 illustrates an example method 800 of UE procedures that is similar to the method 500 and 600, with differences described below. At block 814, the UE (e.g., UE 102) receives a UL switching configuration (e.g., events 314, 514), including UL Tx switching period location indication of cach UL switching case (e.g., band pairs). At block 835, the UE 102 determines the UL Tx switching period location in accordance with the current UL switching case (e.g., band pairs).

Regarding the UL switching configuration at block 814, in some implementations, the switching period location indication includes a bitmap (e.g., SwitchingPeriodLocationList) under cell group configuration (e.g., RRC parameter CellGroupConfig), which has the same length as the band pair list (e.g., RRC parameter supportedBandPairListNR in the UE capability) for UL switching. The first bit in the bitmap indicates the switching period location of the first band pair in the band pair list. The bit is set to 0 to indicate that the switching period location occurs in cell(s) on the first band (e.g., RRC parameter bandIndexUL1 in ULTxSwitchingBandPair) in the first band pair, and the bit is set to 1 to indicate that the switching period location occurs in cell(s) on the second band (e.g., RRC parameter bandIndexUL2 in ULTxSwitchingBandPair) in the first band pair, or vice versa. Thus, the UE 102 follows the bitmap to determine the timing, either in the first or second band, for Tx switching.

Regarding block 814 and the UL switching configuration, in some other implementations, the switching period location indication is configured per the serving cell. For example, in scenario 300, the base station 104 configures, for the UE 102, an information element (IE) UplinkTxSwitchConfig in ServingCellConfig of a first cell, wherein the UplinkTxSwitchConfig includes a parameter SwitchingPeriodLocation-Presence that indicates a list of serving cell indexes (e.g., ServCellIndex, SCellIndex, PCellIndex, uplinkTxSwitchingIndex). If the UE 102 performs antenna switching from the first cell to a second cell that is in the list (e.g., SwitchingPeriodLocation-Presence), the UE 102 determines that the Tx switching period location is in the time resources in the first cell.

In still other implementations, the UplinkTxSwitchConfig of a first cell includes a parameter SwitchingPeriodLocation-PresenceInTargetCell that indicates a list of serving cell indexes (e.g., ServCellIndex, SCellIndex, PCellIndex, uplinkTxSwitchingIndex). If the UE 102 performs Tx switching from the first cell to a second cell that is in the list (e.g., SwitchingPeriodLocation-PresenceInTargetCell), the UE 102 determines that the Tx switching period location is in the time resources in the second cell.

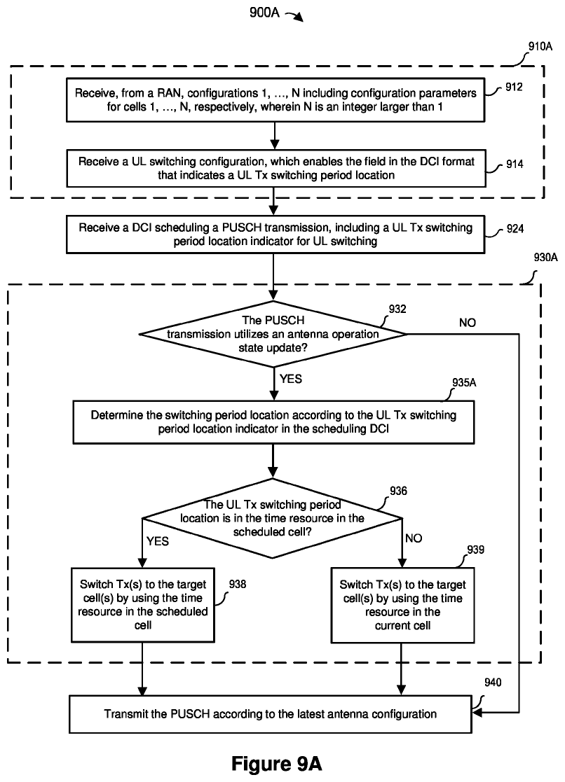

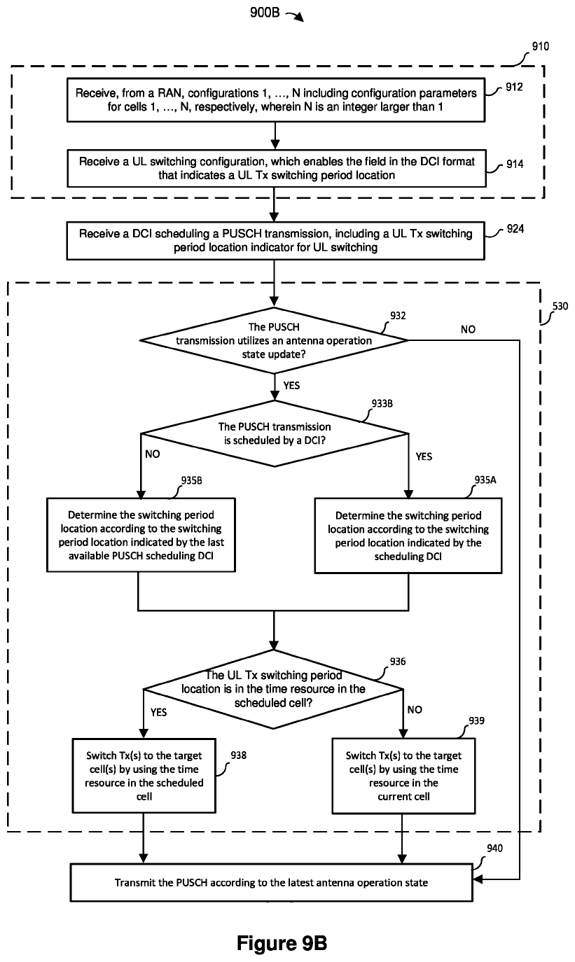

FIG. 9A illustrates an example method 900A of UE procedures that is similar to the method 500 and 600, with differences described below. At block 914, the UE (e.g., UE 102) receives a UL switching configuration (e.g., events 314, 514), which enables the UL Tx switching period indicator field in the DCI format. At block 924, the UE 102 receives a DCI, which schedules a PUSCH transmission and includes the UL Tx switching period indicator. At block 935A, the UE 102 updates Tx states by using the time resource in the cell that is indicated by the UL Tx switching period indicator.

In some implementations, the UL Tx switching period indicator field is a one bit flag. The bit is set to 0 to indicate the current cell, and the bit is set to 1 to indicates the scheduled cell.

The example for method 900A applicable to scenario 300 is similar to the example of method 600 applicable to scenario 300, with differences described below. The base station 104 transmits 314, to the UE 102, the UL configuration enabling the UL Tx switching period location indicator in the DCI format. The base station transmits 324, to the UE 102, a first DCI indicating a first UL Tx switching period location. At event 335, the UE 102 determine the UL Tx switching period location in accordance with the first UL Tx switching period location indicated by the first DCI.

FIG. 9B illustrates an example method 900B of UE procedures that is similar to the method 500, 600, and 900A, with differences described below. At block 922B, the UE (e.g., UE 102) receives a configured grant (e.g., event 322, 522) to transmit PUSCH(s) (e.g., 342 the second PUSCH). At block 931B, if the PUSCH is scheduled by a DCI, the flow proceeds to block 935A. At block 931B, if the PUSCH is not scheduled by a DCI, the flow proceeds to the block 935B. At block 935B, the UE 102 determines the UL Tx switching period location based on the UL Tx switching period location indicator in the last scheduling DCI.

The example for method 900B applicable to scenario 300 is similar to the example of method 900A applicable to scenario 300, with differences described below. The UE 102 receives 322, from base station 104, a configured grant scheduling 342 the second PUSCH transmission. If the UE 102 is to transmit the 342 the second PUSCH to the base station 104 and utilizes a Tx state update, the UE 102 determines 333 the second UL Tx switching period location according to the UL Tx switching period in 324 the first DCI (the last scheduling DCI before block 342).

The disclosed methods can also apply to other UL channels, for example, PUCCH transmissions triggered by dynamic or semi-persistent scheduled downlink transmission (e.g., HARQ feedback, scheduling request), or RRC configured UL transmission (e.g., channel state information report).

In some implementations, the serving cell index, cell index, carrier index, cell(s)/band indication, and/or Tx states indication in method 600, 700B, 800, 900A, and 900B refer to a carrier index (e.g., uplinkTxSwitchingCarrier with a value of ENUMERATED {carrier1, carrier2, carrier 3}) configured in UL switching configuration (e.g., uplinkTxSwitching) in each serving cell configurations (e.g., ServingCellConfig). If the frequency range of multiple cells are in the same band and can be operated with a single Tx in a UE, the base station configures, to the UE, the same carrier index to these cells.

In some other implementations, the serving cell index, cell index, carrier index, cell(s)/band indication, and/or Tx states indication in method 600, 700B, 800, 900A, and 900B refer to a cell index (e.g., secondary cell index, SCellIndex) configured in the cell group configuration (e.g., CellGroupConfig) for cross carrier scheduling. In some implementations, for the primary cell (PCell or special cell in a cell group), the cell index is 0, a default value, or a cell index (e.g., PCellIndex) configured by the base station.

In some examples, the base station configures method 900A/900B according to techniques of method 600/700A/700B/800. For a PUSCH scheduled by a DCI format, the UE may apply techniques of method 900A/900B to determine a UL Tx switching period location. Otherwise, the UE may apply techniques of method 600/700A/700B/800 to determine a UL Tx switching period location.

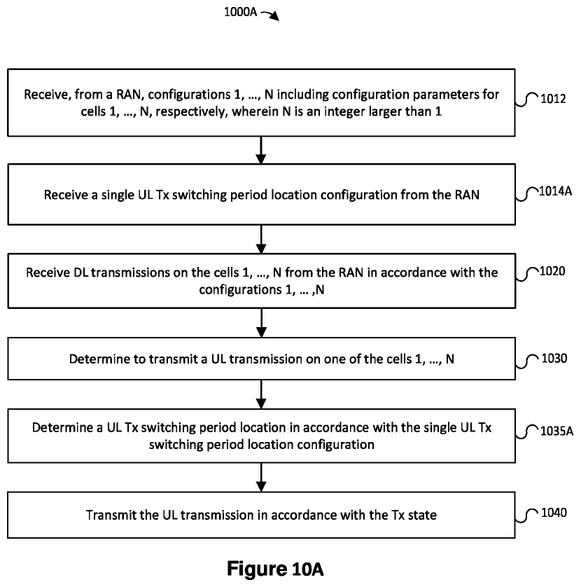

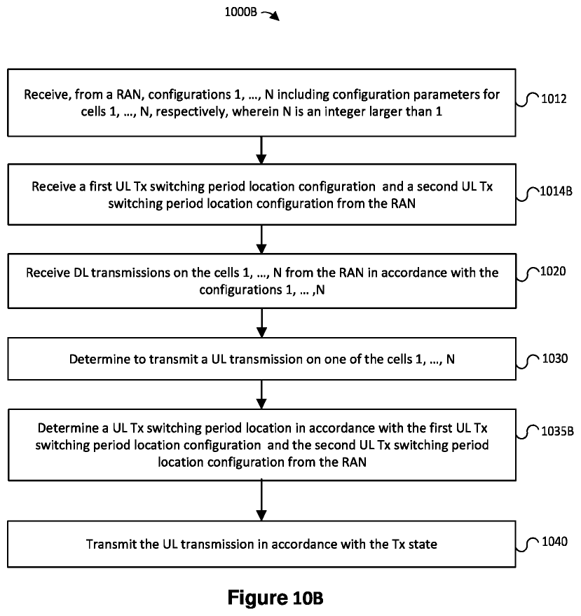

FIGS. 10A and 10B provide descriptions of applying single or multiple techniques from methods 600, 700A, 700B, 800, 900A, 900B on determining UL Tx switching period location. Similar to FIGS. 6-9B, events in FIGS. 10A-10C that are similar to those of FIGS. 5-9B are labeled with similar reference numbers (e.g., event 512 is similar to event 1012 of FIGS. 10A-10C, etc.), with differences discussed below where appropriate. With the exception of the differences shown in the figures and discussed below, any of the alternative implementations discussed with respect to a particular event (e.g., for messaging and processing) may apply to events labeled with similar reference numbers in other figures.

FIG. 10A illustrates an example method 1000A similar to method 500, addressing the UE behaviors communicating with the RAN. In some implementations, the Tx states determination procedures are based on a single UL Tx switching period configuration. Differences between method 1000A and method 500 are described below. At block 1014A, the UE (e.g., UE 102) receives a single UL Tx switching period configuration from the RAN (e.g., 514, 614, 714A, 814, 914). At block 1035A, the UE 102 determines UL Tx switching period location in accordance with the single UL Tx switching period configuration.

FIG. 10B illustrates an example method 1000B similar to method 500 and 1000A, with differences described below. At block 1014A, the UE (e.g., UE 102) receives a first and a second UL switching UL Tx switching period configurations from the RAN (e.g., 514, 614, 714A, 814, 914). At block 1035A, the UE 102 determines UL Tx switching period location in accordance with the first and second UL Tx switching period configurations.

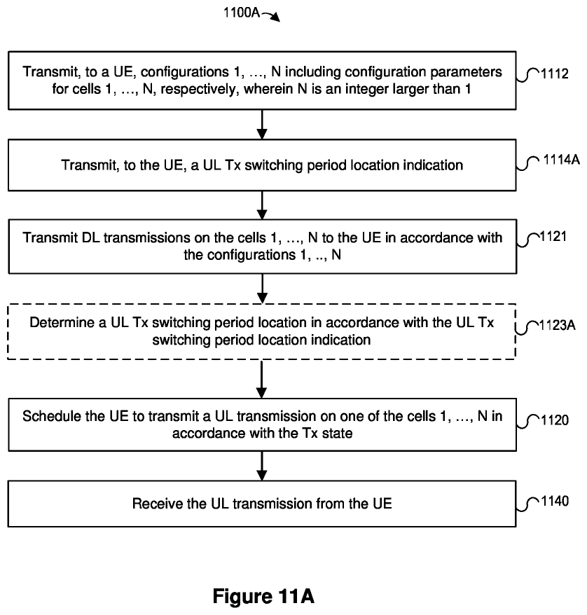

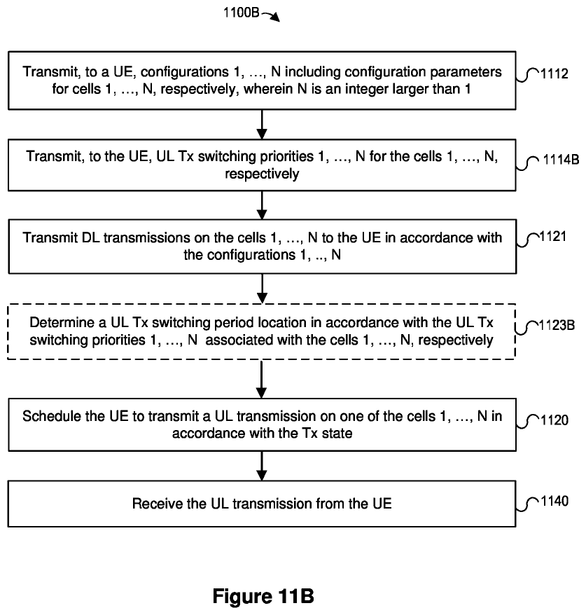

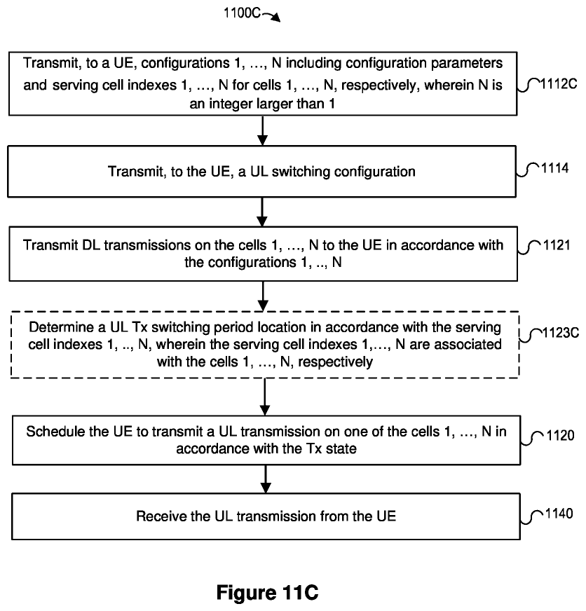

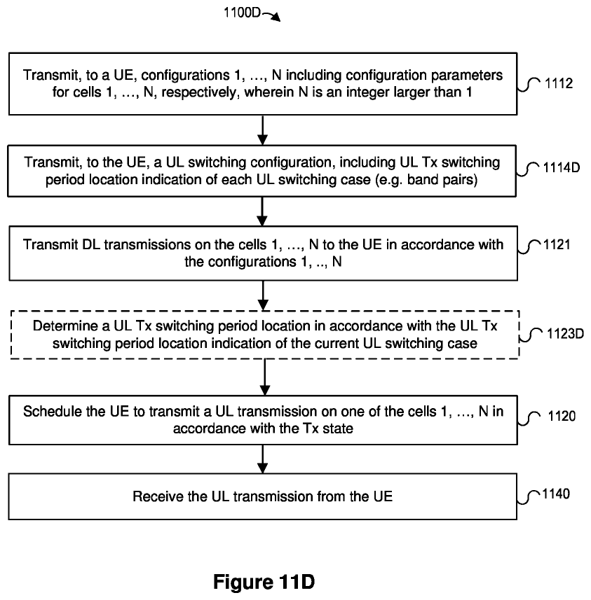

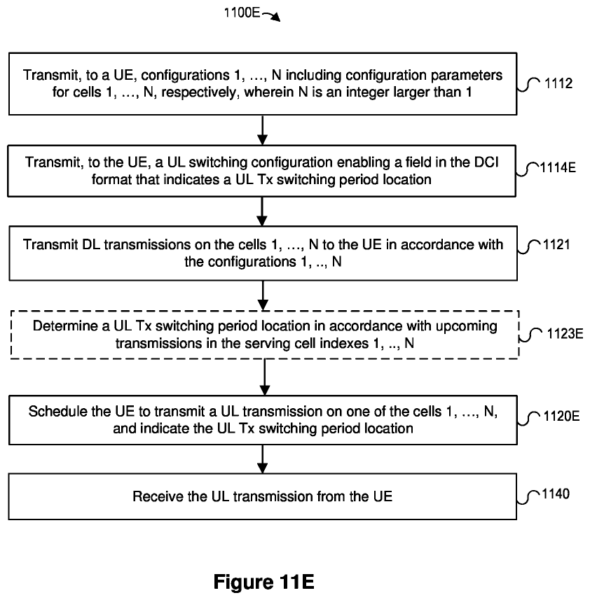

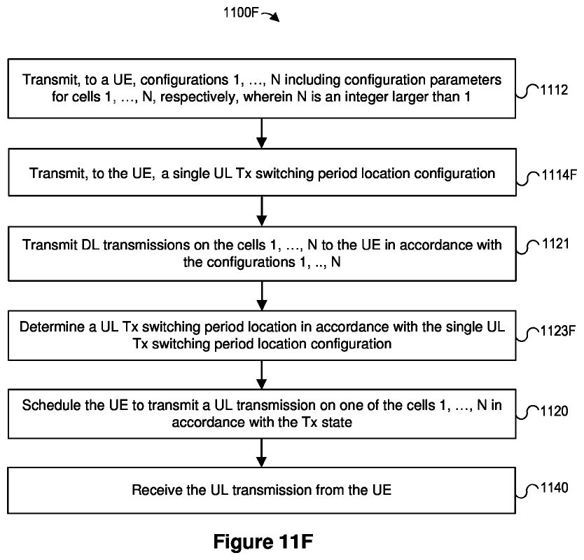

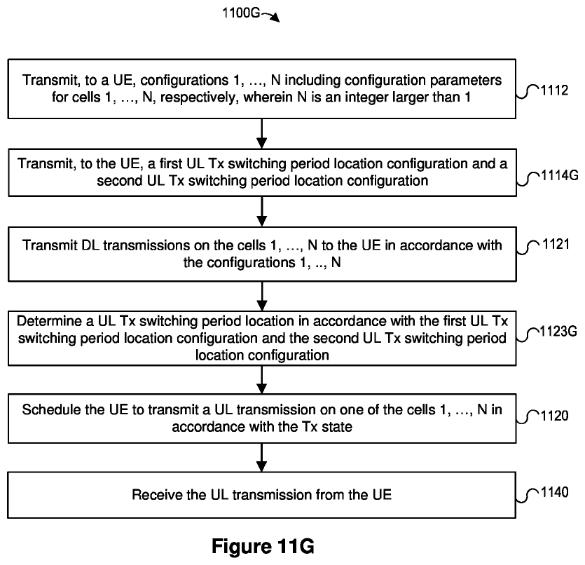

FIGS. 11A, 11B, 11C, 11D, 11E, 11F, and 11G illustrate base station procedures configuring UL Tx switching period configurations and/or indicating UL Tx switching period locations to the UE. Similar to FIGS. 6-10C, events in FIGS. 11A-11G that are similar to those of FIGS. 5-10C are labeled with similar reference numbers (e.g., event 512 is similar to event 1112 of FIGS. 11A-11G, etc.), with differences discussed below where appropriate. With the exception of the differences shown in the figures and discussed below, any of the alternative implementations discussed with respect to a particular event (e.g., for messaging and processing) may apply to events labeled with similar reference numbers in other figures.

FIG. 11A illustrates an example method 1100A reflecting a base station perspective similar to the UE perspective of method 600. The flow begins with block 1112, the base station (e.g., BS 104) transmits, to a UE, configurations 1, . . . , N including configuration parameters for cells 1, . . . , N, respectively, wherein N is an integer larger than 1 (e.g., events 512). At block 1114A, the base station 104 transmits, to the UE (e.g., UE 102), a UL Tx switching period indication (e.g., event 614). At block 1121, the base station 104 transmits DL transmissions on the cells 1, . . . , N to the UE 102 in accordance with the configurations 1, . . . , N (e.g., event 520). At block 1123A, the base station 104 determines a UL Tx switching period in accordance with the UL Tx switching period indication (e.g., event 635). At block 1120, the base station 104 schedules for the UE 102 to transmit a UL transmission on one of the cells 1, . . . , N in accordance with the Tx state. At block 1140, the base station receives the UL transmission from the UE 102 (e.g., event 540).

FIG. 11B illustrates an example method 1100B reflecting a base station perspective similar to the UE perspective of method 700A. The method 1100B is similar to method 1100A, with differences described below. At block 1114B, the base station 104 transmits, to the UE 102, UL Tx switching priorities 1, . . . , N for the cells 1, . . . , N, respectively (e.g., event 714A). At block 1123B, the base station 104 determines UL Tx switching period location in accordance with the UL Tx switching priorities 1, . . . , N associated with the cells 1, . . . , N, respectively.

FIG. 11C illustrates an example method 1100C reflecting a base station perspective similar to the UE perspective of method 700B. The method 1100C is similar to method 1100A, with differences described below. At block 1112C, the base station 104 transmits, to a UE 102, configurations 1, . . . , N including configuration parameters and serving cell indexes 1, . . . , N for cells 1, . . . , N, respectively, wherein N is an integer larger than 1 (e.g., 712B). At block 1114, the base station 104 transmits, to the UE 102, a UL switching configuration (e.g., event 514). At block 1123C, the base station 104 determines the UL Tx switching period location in accordance with the serving cell indexes 1, . . . , N, wherein the serving cell indexes 1, . . . , N are associated with the cells 1, . . . , N, respectively.

FIG. 11D illustrates an example method 1100D reflecting a base station perspective similar to the UE perspective of 800. The method 1100D is similar to method 1100A, with differences described below. At block 1114D, the base station 104 transmits, to the UE 102, a UL Tx switching period location configuration of each UL switching case (e.g., band pairs). At block 1123D, the base station 104 determines a UL Tx switching period location in accordance with the UL Tx switching period location configuration of the current UL switching case.

FIG. 11E illustrates and example method 1100E reflecting a base station perspective similar to the UE perspective of 900A and 900B. The method 1100E is similar to method 1100A, with differences described below. At block 1114E, the base station 104 transmits, to the UE 102, a UL switching configuration enabling a field in the DCI format indicating a UL Tx switching period location. At block 1123E, the base station 104 determines a Tx state in accordance with upcoming transmissions in the serving cell indexes 1, . . . , N. At block 1120E, the base station 104 schedules for the UE 102 to transmit a UL transmission on one of the cells 1, . . . , N, and indicate the UL Tx switching period location in the scheduling DCI.

FIG. 11F illustrates and example method 1100F reflecting a base station perspective similar to the UE perspective of method 1000A. The method 1100F is similar to method 1100A, with differences described below. At block 1114F, the base station 104 transmits a single UL Tx switching period location configuration to the UE 102. At block 1123F, the base station 104 determines a Tx state in accordance with the single UL Tx switching period location configuration.

FIG. 11G illustrates and example method 1100G reflecting a base station perspective similar to the UE perspective of method 1000B. The method 1100G is similar to method 1100A, with differences described below. At block 1114G, the base station 104 transmits a first UL Tx switching period location configuration and a second UL Tx switching period location configuration to the UE 102. At block 1123G, the base station 104 determines a Tx state in accordance with the first UL Tx switching period location configuration and a second UL Tx switching period location configuration.

In some implementation, the base station proceeds to block 1120 from block 1121 (e.g., skipping events 1123A, 1123B, 1123C, 1123D, 1123E, 1123F, 1123G).

The following additional considerations apply to the foregoing discussion.

In some implementations, “message” is used and can be replaced by “information element (IE)”. In some implementations, “IE” is used and can be replaced by “field”. In some implementations, “configuration” can be replaced by “configurations” or the configuration parameters.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may be software modules (e.g., code, or machine-readable instructions stored on non-transitory machine-readable medium) or hardware modules. A hardware module is a tangible unit capable of performing certain operations and may be configured or arranged in a certain manner. A hardware module can include dedicated circuitry or logic that is permanently configured (e.g., as a special-purpose processor, such as a field programmable gate array (FPGA) or an application-specific integrated circuit (ASIC), a digital signal processor (DSP)) to perform certain operations. A hardware module may also include programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional and alternative structural and functional designs for managing radio bearers through the principles disclosed herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

What is claimed is:

1. A method in a user equipment (UE) equipped with a plurality of transmitters, the method comprising:
receiving, from a radio access network (RAN), an uplink switching configuration that indicates, for a plurality of frequency bands including a first frequency band and a second frequency band, respective priorities; and
determining, for an uplink transmission to the RAN and based on the respective priorities, whether to allocate a time resource in a first slot associated with the first frequency band or a second slot associated with the second frequency band, the time resource being for the UE to configure at least one of the plurality of transmitters for the second frequency band.

2. The method of claim 1, wherein the uplink transmission is a physical uplink shared channel (PUSCH) transmission.

3. The method of claim 2, further comprising:
receiving, from the RAN, a downlink control information (DCI) scheduling the PUSCH transmission.

4. The method of claim 3, wherein the time resource is a first time resource and the PUSCH transmission is a first PUSCH transmission, and wherein the method further comprises:
receiving, from the RAN, a configured grant scheduling a second PUSCH transmission; and
determining, for the second PUSCH transmission and based on the respective priorities, whether to allocate a second time resource in a third slot associated with the first frequency band or a fourth slot associated with the second frequency band, the second time resource being for the UE to configure at least one of the plurality of transmitters for the second frequency band.

5. The method of any one of claims 1-4, further comprising:
before receiving the uplink switching configuration, transmitting, to the RAN, capabilities of the UE for uplink transmitter switching for the plurality of frequency bands.

6. The method of any one of claims 1-5, further comprising:
when determining to allocate the time resource in the first slot, switching the at least one of the plurality of transmitters from the first frequency band to the second frequency band during the first slot; and
when determining to allocate the time resource in the second slot, switching the at least one of the plurality of transmitters from the first frequency band to the second frequency band during the second slot.

7. A user equipment (UE) comprising one or more processors and configured to perform the method of any one of claims 1-6.

8. A method in a radio access network (RAN) node, the method comprising:
transmitting, to a user equipment (UE) equipped with a plurality of transmitters, an uplink switching configuration that indicates, for a plurality of frequency bands including a first frequency band and a second frequency band, respective priorities, the respective priorities being for use by the UE to determine, for an uplink transmission to the RAN, whether to allocate a time resource in a first slot associated with the first frequency band or a second slot associated with the second frequency band, and the time resource being for the UE to configure at least one of the plurality of transmitters for the second frequency band.

9. The method of claim 8, wherein the uplink transmission is a physical uplink shared channel (PUSCH) transmission.

10. The method of claim 9, further comprising:
transmitting, to the UE, a downlink control information (DCI) scheduling the PUSCH transmission.

11. The method of claim 10, wherein the time resource is a first time resource and the PUSCH transmission is a first PUSCH transmission, and wherein the method further comprises:
transmitting, to the UE, a configured grant scheduling a second PUSCH transmission, the respective priorities further being for use by the UE to determine, for the second PUSCH transmission, whether to allocate a second time resource in a third slot associated with the first frequency band or a fourth slot associated with the second frequency band, and the second time resource being for the UE to configure at least one of the plurality of transmitters for the second frequency band.

12. The method of any one of claims 8-11, further comprising:
before transmitting the uplink switching configuration, receiving from the UE, capabilities of the UE for uplink transmitter switching for the plurality of frequency bands.

13. A radio access network (RAN) node comprising one or more processors and configured to perform the method of any one of claims 8-12.

14. The RAN node of claim 13, wherein the RAN node comprises a master node and a secondary node, and wherein the master node performs the transmitting the uplink switching configuration.

15. The RAN node of claim 13, wherein the RAN node comprises a master node and a secondary node, and wherein the secondary node performs the transmitting the uplink switching configuration.
